(19) United States
(12) Patent Application Publication
(10) Pub. No.: US 2026/0155616 A1
(43) Pub. Date: Jun. 4, 2026

(54) LASER CHAMBER AND ELECTRONIC DEVICE MANUFACTURING METHOD

(71) Applicant: Gigaphoton Inc., Oyama-shi (JP)

(72) Inventors: Hitoshi OHGA, Oyama-shi (JP); Youichi YAMANOUCHI, Oyama-shi (JP)

(73) Assignee: Gigaphoton Inc., Oyama-shi (JP)

(21) Appl. No.: 19/381,745

(22) Filed: Nov. 6, 2025

(30) Foreign Application Priority Data
Dec. 3, 2024 (JP) 2024-209857

(51) Int. Cl. H01S 3/036

(52) U.S. Cl. CPC H01S 3/036

(57) ABSTRACT

A laser chamber includes a container configured to accommodate a laser gas; a pair of discharge electrodes; a fan configured to cause the laser gas to circulate; a first guide including a first surface and a second surface, the first surface being configured to guide the laser gas therealong, and the second surface and an inner surface of the container forming a first space that narrows in a first direction toward depth; and a second guide including a third surface configured to guide the laser gas therealong toward a vicinity of the first guide.

### CROSS-REFERENCE TO RELATED APPLICATIONS

The present application claims the benefit of Japanese Patent Application No. 2024-209857, filed on December 3, 2024, the entire contents of which are hereby incorporated by reference.

### BACKGROUND

### Technical Field

The present disclosure relates to a laser chamber and an electronic device manufacturing method.

### Related Art

Recently, in a semiconductor exposure apparatus, improvement in resolution has been desired for miniaturization and high integration of semiconductor integrated circuits. For this purpose, an exposure light source that outputs light having a shorter wavelength has been developed. For example, as a gas laser device for exposure, a KrF excimer laser device for outputting laser light having a wavelength of about 248 nm and an ArF excimer laser device for outputting laser light having a wavelength of about 193 nm are used.

Since excimer laser light output from a KrF excimer laser device or an ArF excimer laser device has a pulse width of several 10 ns and a wavelength thereof is short as about 248 nm or 193 nm, excimer laser light is sometimes used for direct processing of a polymer material, a glass material, or the like. Chemical bonds in polymeric materials can be broken by excimer laser light having a photon energy higher than the bond energy. Therefore, it is known that non-heating processing of polymeric materials is possible with excimer laser light, and that the processing shape is beautiful.

Further, it is known that, since glass, ceramics, and the like have high absorptance with respect to excimer laser light, even a material that is difficult to be processed with visible and infrared laser light can be processed with excimer laser light.

### LIST OF DOCUMENTS

### Patent Documents

Patent Document 1: Japanese Patent Application Publication No. 2007-208183

Patent Document 2: US Patent Application Publication No. 2003/031225

Patent Document 3: US Patent No. 5978405

### SUMMARY

A laser chamber according to an aspect of the present disclosure includes a container configured to accommodate a laser gas; a pair of discharge electrodes; a fan configured to cause the laser gas to circulate; a first guide including a first surface and a second surface, the first surface being configured to guide the laser gas therealong, and the second surface and an inner surface of the container forming a first space that narrows in a first direction toward depth; and a second guide including a third surface configured to guide the laser gas therealong toward a vicinity of the first guide.

An electronic device manufacturing method according to an aspect of the present disclosure includes generating laser light using a discharge-excitation-type gas laser device including a laser chamber, outputting the laser light to an exposure apparatus, and exposing a photosensitive substrate to the laser light in the exposure apparatus to manufacture an electronic device. Here, the laser chamber includes a container configured to accommodate a laser gas; a pair of discharge electrodes; a fan configured to cause the laser gas to circulate; a first guide including a first surface and a second surface, the first surface being configured to guide the laser gas therealong, and the second surface and an inner surface of the container forming a first space that narrows in a first direction toward depth; and a second guide including a third surface configured to guide the laser gas therealong toward a vicinity of the first guide.

### BRIEF DESCRIPTION OF THE DRAWINGS

Embodiments of the present disclosure will be described below merely as examples with reference to the accompanying drawings.

FIG. 1 shows the configuration of a laser device of a comparative example.

FIG. 2 shows the configuration of a laser chamber in the comparative example viewed in a -Z direction.

FIG. 3 shows the vicinity of the boundary between a first guide and an inclined member in the comparative example in an enlarged manner.

FIG. 4 shows the vicinity of the boundary between the first guide and the inclined member in a first embodiment in an enlarged manner.

FIG. 5 is a perspective view showing a part of the first guide in the first embodiment.

FIG. 6 shows the vicinity of the boundary between the first guide and the inclined member in a second embodiment in an enlarged manner.

FIG. 7 shows the vicinity of the boundary between the first guide and the inclined member in a third embodiment in an enlarged manner.

FIG. 8 shows the vicinity of the boundary between the first guide and the inclined member in a fourth embodiment in an enlarged manner.

FIG. 9 shows the vicinity of the boundary between the first guide and the inclined member in a fifth embodiment in an enlarged manner.

FIG. 10 shows first and second virtual logarithmic spirals.

FIG. 11 shows the configuration of the laser chamber in the fifth embodiment as viewed in the -Z direction.

FIG. 12 shows the configuration of an exposure system.

### DESCRIPTION OF EMBODIMENTS

### Contents

### 1. Comparative example

1.1 Configuration

1.2 Operation

2. Problem of comparative example

3. Laser chamber 10 having first space A1 between first guide 10d and inner surface of container 19

3.1 Configuration

3.2 Effect

4. Laser chamber 10 having sound absorbing material 10g arranged in first space A1

4.1 Configuration

4.2 Effect

5. Laser chamber 10 having second space A2 behind first space A1

5.1 Configuration

5.2 Effect

6. Laser chamber 10 in which angle between second surface 42 and inner surface of container 19 varies in accordance with position in H direction

6.1 Configuration

6.2 Effect

7. Laser chamber 10h in which cross section of first surface 41 has logarithmic spiral shape

7.1 Configuration

7.2 Effect

8. Others

8.1 Electronic device manufacturing method

8.2 Laser control processor 30

8.3 Supplement

Hereinafter, embodiments of the present disclosure will be described in detail with reference to the drawings. The embodiments described below show some examples of the present disclosure and do not limit the contents of the present disclosure. Also, all configurations and operation described in the embodiments are not necessarily essential as configurations and operation of the present disclosure. Here, the same components are denoted by the same reference numeral, and duplicate description thereof is omitted.

### COMPARATIVE EXAMPLE

### 1.1 Configuration

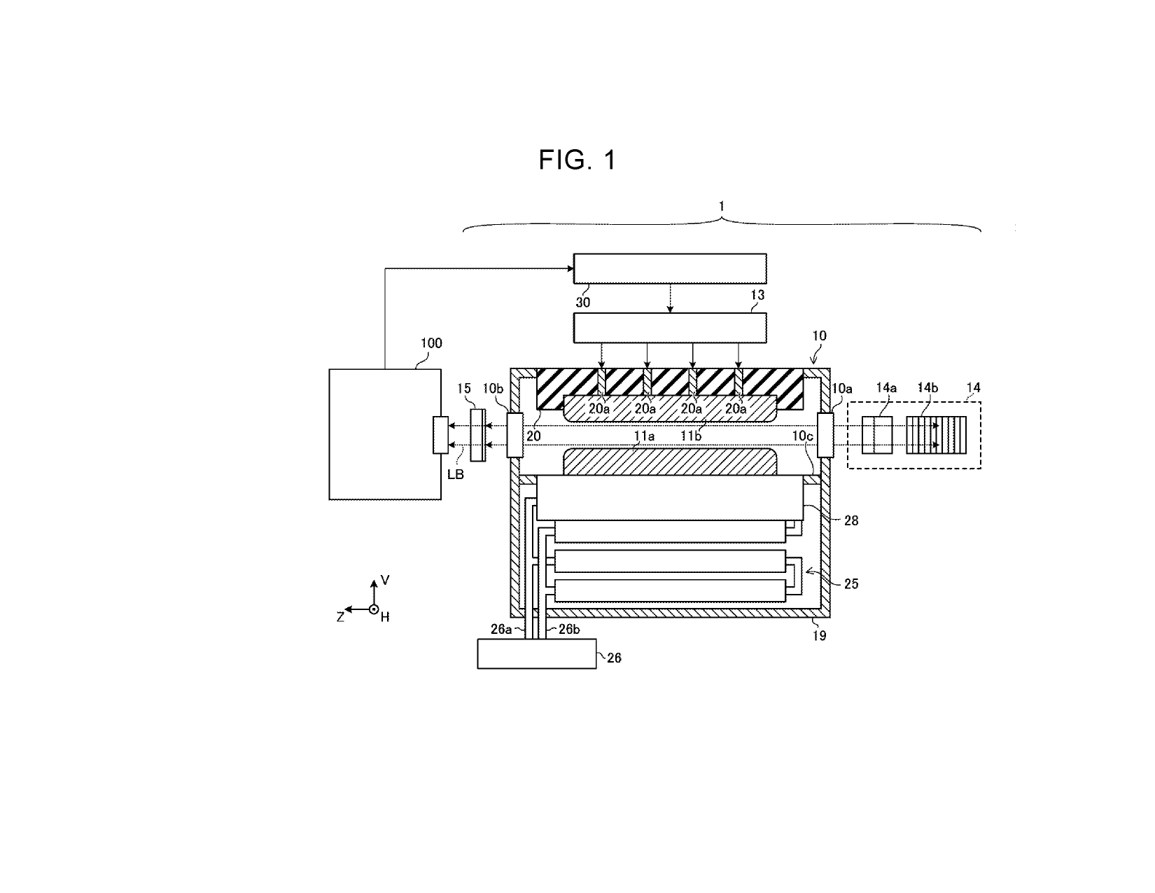

FIG. 1 shows the configuration of a laser device 1 of a comparative example. The comparative example of the present disclosure is an example recognized by the applicant as known only by the applicant, and is not a publicly known example admitted by the applicant.

The laser device 1 is a discharge-excitation-type gas laser device capable of outputting laser light LB to an exposure apparatus 100. The laser device 1 includes a laser chamber 10, a power source device 13, a line narrowing module 14, an output coupling mirror 15, a heat exchanger 26, and a laser control processor 30. The line narrowing module 14 and the output coupling mirror 15 configure an optical resonator. The laser chamber 10 includes windows 10a, 10b, first and second discharge electrodes 11a, 11b, and a container 19. The laser chamber 10 is arranged such that the windows 10a, 10b are located on the optical path of the optical resonator. The laser control processor 30 will be described later.

The line narrowing module 14 includes a prism 14a and a grating 14b. The prism 14a is arranged on the optical path of light output from the window 10a. The grating 14b is arranged on the optical path of the light having transmitted through the prism 14a. The output coupling mirror 15 is configured by a partial reflection mirror.

The travel direction of the laser light LB output from the output coupling mirror 15 is represented by a Z direction. Each of the first and second discharge electrodes 11a, 11b extends in the Z direction. The direction in which the first and second discharge electrodes 11a, 11b face each other is represented by a V direction or a -V direction. The Z direction and the V direction are perpendicular to each other, and the direction perpendicular to both of them is represented by an H direction or a -H direction. In FIG. 1, the configuration of the laser device 1 is shown as viewed in the -H direction.

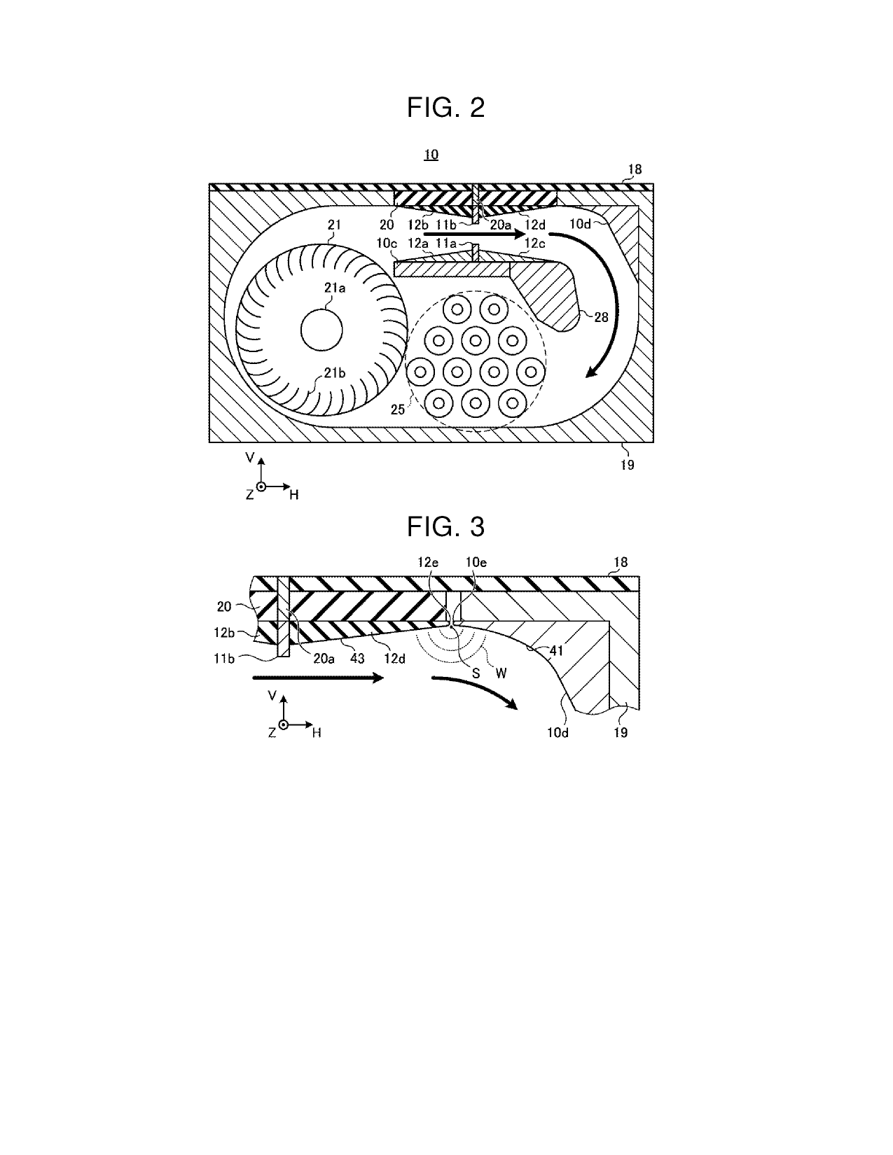

FIG. 2 shows the configuration of the laser chamber 10 in the comparative example viewed in a -Z direction. The laser chamber 10 includes a container 19, and the container 19 accommodates a first guide 10d, the first and second discharge electrodes 11a, 11b, inclined members 12a to 12d, a cross flow fan 21, a cooling unit 25, and a guide portion 28. The inclined member 12d corresponds to the second guide in the present disclosure. The cross flow fan 21 corresponds to the fan in the present disclosure.

The container 19 is filled with a laser gas containing, for example, an argon gas or a krypton gas as a rare gas, a fluorine gas as a halogen gas, a neon gas as a buffer gas, and the like. Alternatively, a laser gas containing a fluorine gas and a buffer gas may be enclosed.

An opening is formed in a part of the container 19, and the opening is closed by an electrically insulating portion 20. The opening is sealed by covering a surface of the container 19 including the position of the opening with a lid portion 18 from the outside of the container 19. The electrically insulating portion 20 supports the second discharge electrode 11b. A plurality of conductive portions 20a are embedded in the electrically insulating portion 20. Each of the conductive portions 20a is electrically connected to the second discharge electrode 11b. The power source device 13 (see FIG. 1) includes a charger (not shown) and is connected to the second discharge electrode 11b via the conductive portions 20a. Each of the inclined members 12b, 12d has a triangular prism shape, and is fixed to the electrically insulating portion 20 so as to cover a part of corresponding side surface of the second discharge electrode 11b.

A return plate 10c is arranged in the laser chamber 10. The first discharge electrode 11a is supported by the return plate 10c. The first discharge electrode 11a is electrically connected to the ground potential via the return plate 10c and a wiring (not shown). As shown in FIG. 2, the return plate 10c defines a gap through which the laser gas passes on each of the front and back sides of the paper surface of FIG. 1. Each of the inclined members 12a, 12c has a triangular prism shape and is fixed to the return plate 10c so as to cover a part of two side surfaces of the first discharge electrode 11a.

The cross flow fan 21 includes a plurality of blades 21b arranged around a rotation shaft 21a. The rotation shaft 21a is connected to a motor (not shown).

The inclined members 12a, 12b are arranged to gradually narrow the flow path of the laser gas so as to efficiently guide the laser gas fed from the cross flow fan 21 to the discharge space between the first and second discharge electrodes 11a, 11b. The inclined members 12c, 12d are arranged to gradually expand the flow path of the laser gas so as to efficiently guide the laser gas having passed through the discharge space in a direction of approaching the guide portion 28.

The guide portion 28 is fixed to the inclined member 12c so as to guide the laser gas having passed between the inclined members 12c, 12d to the cooling unit 25.

The cooling unit 25 includes a plurality of refrigerant pipes and heat radiation fins arranged around each of the refrigerant pipes. Each of the refrigerant pipes is arranged such that the longitudinal direction thereof extends in the Z direction. The refrigerant pipes are connected to the heat exchanger 26 via pipes 26a, 26b (see FIG. 1).

### 1.2 Operation

The laser control processor 30 receives a target value of a pulse energy E and a light emission trigger signal from the exposure apparatus 100. The laser control processor 30 transmits setting data of a charge voltage to the charger included in the power source device 13 based on the target value of the pulse energy E. Further, the laser control processor 30 transmits a trigger signal to the power source device 13 based on the light emission trigger signal.

Upon receiving the trigger signal from the laser control processor 30, the power source device 13 generates a pulse high voltage from the electric energy charged to the charger and applies the high voltage between the first and second discharge electrodes 11a, 11b.

When the high voltage is applied between the first and second discharge electrodes 11a, 11b, discharge occurs between the first and second discharge electrodes 11a, 11b. The laser medium in the laser chamber 10 is excited by the energy of the discharge and shifts to a high energy level. When the excited laser medium then shifts to a low energy level, light having a wavelength corresponding to the difference between the energy levels is emitted.

The light generated in the laser chamber 10 is output to the outside of the laser chamber 10 through the windows 10a, 10b. The beam width of the light output through the window 10a of the laser chamber 10 is expanded in the plane parallel to an HZ plane by the prism 14a, and then the light is incident on the grating 14b.

The light incident on the grating 14b is reflected by a plurality of grooves of the grating 14b and is diffracted in a direction corresponding to the wavelength of the light. By matching the incident angle of the light incident on the grating 14b with the diffraction angle of the diffracted light having a desired wavelength, the wavelength of the diffracted light returning to the prism 14a from the grating 14b is selected. The prism 14a reduces the beam width, in the plane parallel to the HZ plane, of the diffracted light returning from the grating 14b and returns the light to the laser chamber 10 through the window 10a.

The output coupling mirror 15 transmits and outputs a part of the light output through the window 10b of the laser chamber 10, and reflects the other part back into the laser chamber 10.

In this way, the light output from the laser chamber 10 reciprocates between the line narrowing module 14 and the output coupling mirror 15. The light is amplified every time it passes through a discharge space between the first and second discharge electrodes 11a, 11b, and is line-narrowed every time the light is turned back by the line narrowing module 14. Thus, the light having undergone laser oscillation and line narrowing is output as the laser light LB from the output coupling mirror 15, and enters the exposure apparatus 100.

When the motor (not shown) rotates the cross flow fan 21, the laser gas flows and circulates through the inside of the laser chamber 10 as indicated by arrows in FIG. 2. Discharge products generated from the laser gas excited by the discharge between the first and second discharge electrodes 11a, 11b are removed from the discharge space by the flow of the laser gas by the time of the subsequent discharge. Accordingly, the discharge space and the vicinity thereof are in a state in which there is little discharge products, so that the discharge can be stabilized. The repeated discharge generates a compression wave of the laser gas, and the compression wave propagates through the inside of the container 19 as an acoustic wave.

### 2. Problem of comparative example

FIG. 3 shows the vicinity of the boundary between the first guide 10d and the inclined member 12d in the comparative example in an enlarged manner. The first guide 10d has a first surface 41 and the inclined member 12d has a third surface 43. The inclined member 12d guides the laser gas along the third surface 43 toward the vicinity of the first guide 10d in the H direction. The first guide 10d guides the laser gas along the first surface 41 toward the cooling unit 25.

A gap exists between the container 19 and the electrically insulating portion 20, and an end part of the gap in the V direction is sealed by the lid portion 18. An upstream end portion 10e of the first guide 10d and a downstream end portion 12e of the inclined member 12d are located at an end part, in the -V direction, of the gap between the container 19 and the electrically insulating portion 20. The upstream end portion 10e is an end part on the upstream side of the gas flow of the laser gas, that is, in the -H direction, and the downstream end portion 12e is an end part on the downstream side of the gas flow of the laser gas, that is, in the H direction.

The position of the first guide 10d is adjusted by inserting a shim (not shown) between the first guide 10d and the inner surface of the container 19 so that a gap or step between the first guide 10d and the inclined member 12d becomes as small as possible. However, due to the issue of the processing accuracy and the necessity of passing the wiring (not shown) connected to the return plate 10c, the first guide 10d and the inclined member 12d cannot completely cover the end part, in the -V direction, of the gap between the container 19 and the electrically insulating portion 20 and form a slight gap. Also, it is not possible to completely eliminate a step.

A part of the acoustic wave propagating from the discharge space between the first and second discharge electrodes 11a, 11b is reflected from a gap or step between the first guide 10d and the inclined member 12d, and propagates radially through the inside of the container 19 as a return acoustic wave W having the position of the gap or the step as a line sound source S. The reason why the sound source of the return acoustic wave W becomes the line sound source S is that the gap or step between the first guide 10d and the inclined member 12d extends in the Z direction and can be regarded as a uniform sound source in the Z direction. The return acoustic wave W may also include an acoustic wave that is a part of the acoustic wave propagating from the discharge space, enters the gap between the container 19 and the electrically insulating portion 20, is irregularly reflected by the wall surface of the gap including the lid portion 18, and propagates radially through the line sound source S.

When the return acoustic wave W reaches the discharge space, density of the laser gas becomes uneven in the discharge space and the refractive index of the light becomes uneven, so that the light intensity distribution of the laser light LB may vary and the beam quality may deteriorate. The embodiments described below relate to suppressing the return acoustic wave W from reaching the discharge space.

### Laser chamber 10 having first space A1 between first guide 10d and inner surface of container 19

### 3.1 Configuration

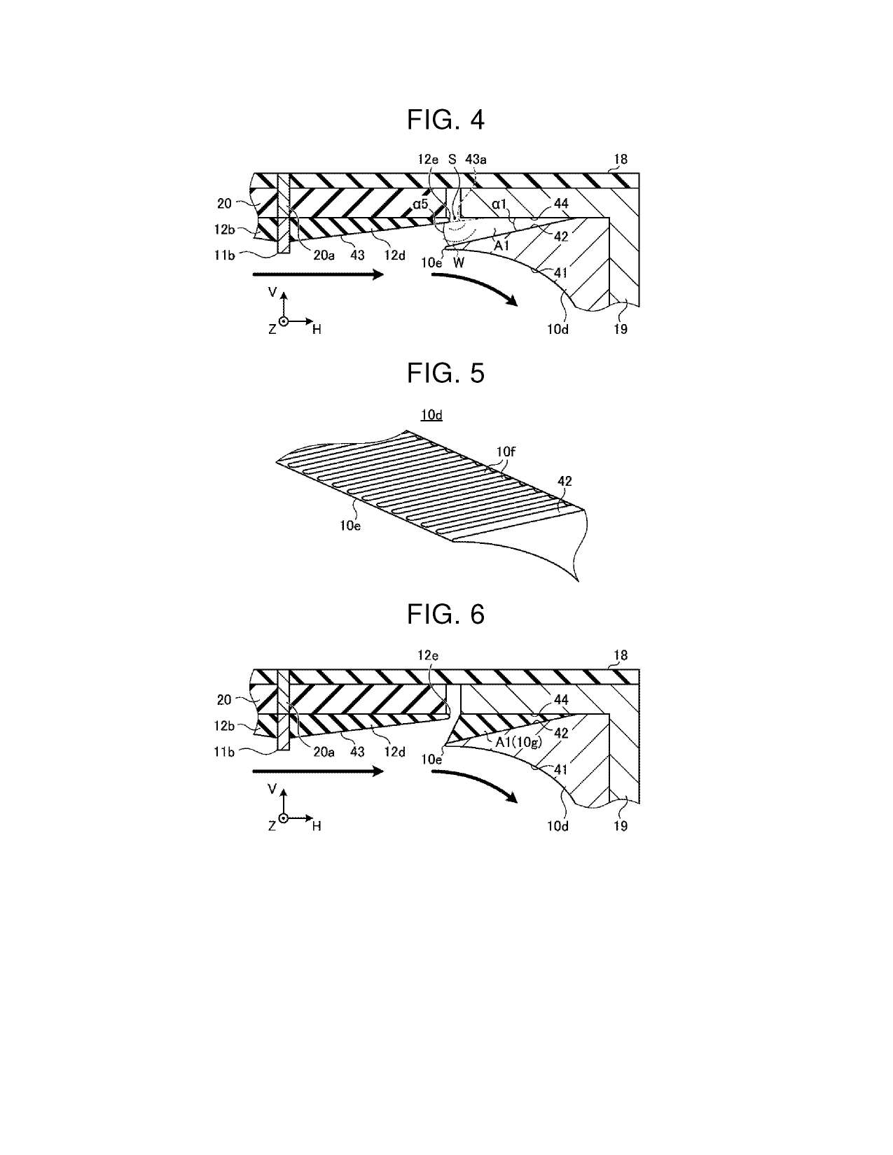

FIG. 4 shows the vicinity of the boundary between the first guide 10d and the inclined member 12d in a first embodiment in an enlarged manner. In the first embodiment, the first guide 10d includes a second surface 42 in addition to the first surface 41, and the second surface 42 and the inner surface of the container 19 form a first space A1 that narrows in the V direction as it extends toward the depth thereof. The direction toward the depth of the first space A1 is represented by a first direction, and the first direction is a direction away from the second discharge electrode 11b. The first direction substantially coincides with the H direction.

With respect to the downstream end portion 12e of the inclined member 12d, the upstream end portion 10e of the first guide 10d is at a different position in a second direction perpendicular to a surface 44, in contact with the first space A1, of the inner surface of the container 19. The second direction substantially coincides with the V direction. Consequently, the position of the line sound source S is slightly different from that in the comparative example, and the line sound source S is retracted to the position of the gap between the container 19 and the inclined member 12d.

It is desirable that the second surface 42 is longer in the H direction than the surface 44. Further, it is desirable that a part of the first guide 10d and a part of the inclined member 12d are at positions overlapping each other when viewed in the second direction.

An angle α1 formed between the second surface 42 and the surface 44 of the container 19 is more than 0° and less than 90°, and is different from 180°/N when N is an arbitrary natural number.

The first space A1 is arranged such that an extension surface 43a of the third surface 43 passes through the first space A1. Further, an angle α5 formed between the third surface 43 and the second surface 42 is more than 0° and less than 90°, and is different from 180°/N when N is an arbitrary natural number. Here, the angle formed between the third surface 43 and the surface 44 of the container 19 is 0° or more and 10° or less.

FIG. 5 is a perspective view showing a part of the first guide 10d in the first embodiment. It is desirable that the first guide 10d has a plurality of grooves 10f on the second surface 42 in contact with the first space A1. Alternatively, the surface 44, in contact with the first space A1, of the inner surface of the container 19 may have the plurality of grooves 10f. The depth of the grooves 10f is desirably a quarter of the wavelength of the acoustic wave. The cross sectional shape of each groove 10f may be rectangular, triangular, or arc-shaped.

### 3.2 Effect

(1) According to the first embodiment, the laser chamber 10 includes the container 19 accommodating the laser gas, the first and second discharge electrodes 11a, 11b, the cross flow fan 21 circulating the laser gas, the first guide 10d, and the inclined member 12d. The first guide 10d includes the first surface 41 and the second surface 42 and guides the laser gas along the first surface 41. The second surface 42 and the inner surface of the container 19 form the first space A1 that narrows in the first direction toward the depth thereof. The inclined member 12d includes the third surface 43 and guides the laser gas along the third surface 43 toward the vicinity of the first guide 10d.

According to the above, even when there is a gap or step between the container 19 and the inclined member 12d, the return acoustic wave W reflected from such a gap or step can be delayed in the timing of returning to the discharge space or attenuated in the first space A1 by being reflected in the first space A1. As a result, it is possible to suppress the return acoustic wave W from reaching the discharge space.

(2) According to the first embodiment, the first direction toward the depth of the first space A1 is the H direction away from the second discharge electrode 11b.

According to the above, it is possible to suppress the acoustic wave having entered the first space A1 from the discharge space from returning to the discharge space.

(3) According to the first embodiment, the angle α1 formed between the second surface 42 and the surface 44, in contact with the first space A1, of the inner surface of the container 19 is more than 0° and less than 90°, and is different from 180°/N when N is an arbitrary natural number.

According to the above, it is possible to prevent the acoustic wave having entered the first space A1 from the discharge space from returning to the discharge space as being reflected N times.

(4) According to the first embodiment, the extension surface 43a of the third surface 43 passes through the first space A1.

According to the above, the acoustic wave generated in the discharge space and reflected by the third surface 43 can be attenuated as entering the first space A1.

(5) According to the first embodiment, the angle α5 formed between the second surface 42 and the third surface 43 is more than 0° and less than 90°, and is different from 180°/N when N is an arbitrary natural number.

According to the above, it is possible to prevent the acoustic wave from returning to the discharge space as being reflected N times by the third surface 43 and the second surface 42.

(6) According to the first embodiment, the upstream end portion 10e of the first guide 10d in the flow direction of the laser gas and the downstream end portion 12e of the inclined member 12d in the flow direction of the laser gas are at different positions in the second direction perpendicular to the surface 44, in contact with the first space A1, of the inner surface of the container 19.

According to the above, it is possible to suppress the acoustic wave from returning to the discharge space without performing adjustment to minimize the gap between the first guide 10d and the inclined member 12d.

(7) According to the first embodiment, the second surface 42 is longer in the first direction than the surface 44, in contact with the first space A1, of the inner surface of the container 19.

According to the above, owing to that the return acoustic wave W reflected from the gap or step between the container 19 and the inclined member 12d is received by the second surface 42 and reflected in the first space A1, the return acoustic wave W can be delayed in the timing of returning to the discharge space or attenuated in the first space A1.

(8) According to the first embodiment, a part of the first guide 10d and a part of the inclined member 12d are at positions overlapping each other when viewed in the second direction perpendicular to the surface 44, in contact with the first space A1, of the inner surface of the container 19.

According to the above, the return acoustic wave W reflected from the gap or step between the container 19 and the inclined member 12d can be more reliably received by the second surface 42.

(9) According to the first embodiment, the plurality of grooves 10f are formed on either the second surface 42 or the surface 44, in contact with the first space A1, of the inner surface of the container 19.

According to the above, phase differences corresponding to the depth of the grooves 10f occur in the acoustic waves reflected in the first space A1, so that the acoustic waves can be attenuated due to mutual cancellation.

In other respects, the first embodiment is similar to the comparative example.

### Laser chamber 10 having sound absorbing material 10g arranged in first space A1

### 4.1 Configuration

FIG. 6 shows the vicinity of the boundary between the first guide 10d and the inclined member 12d in a second embodiment in an enlarged manner. In the second embodiment, a sound absorbing material 10g is arranged in the first space A1 between the second surface 42 and the inner surface of the container 19. The sound absorbing material 10g may have, for example, a triangular prism shape, and all or a part of the first space A1 may be filled with the sound absorbing material 10g. Alternatively, the sound absorbing material 10g may be arranged so as to cover all or a part of either the second surface 42 or the surface 44.

The material of the sound absorbing material 10g may be foamed nickel-based material or porous alumina. Any of the above is difficult to react with the fluorine gas, and thus is difficult to deteriorate. Foamed nickel-based material is superior in sound absorbability and processability. However, since porous alumina is an insulator, a short circuit can be suppressed even when the second discharge electrode 11b is close to the porous alumina.

### 4.2 Effect

(10) According to the second embodiment, the sound absorbing material 10g is arranged in the first space A1.

According to the above, reflection of the acoustic wave can be suppressed by arranging the sound absorbing material 10g, and the acoustic wave can be attenuated in the first space A1. Further, inflow of the laser gas into the first space A1 can be suppressed by arranging the sound absorbing material 10g, and stagnation of the gas can be suppressed.

(11) According to the second embodiment, the sound absorbing material 10g may be arranged so as to cover either the second surface 42 or the surface 44, in contact with the first space A1, of the inner surface of the container 19.

According to the above, reflection of the acoustic wave can be suppressed in the first space A1, and the acoustic wave can be attenuated in the first space A1.

In other respects, the second embodiment is similar to the first embodiment.

### Laser chamber 10 having second space A2 behind first space A1

### 5.1 Configuration

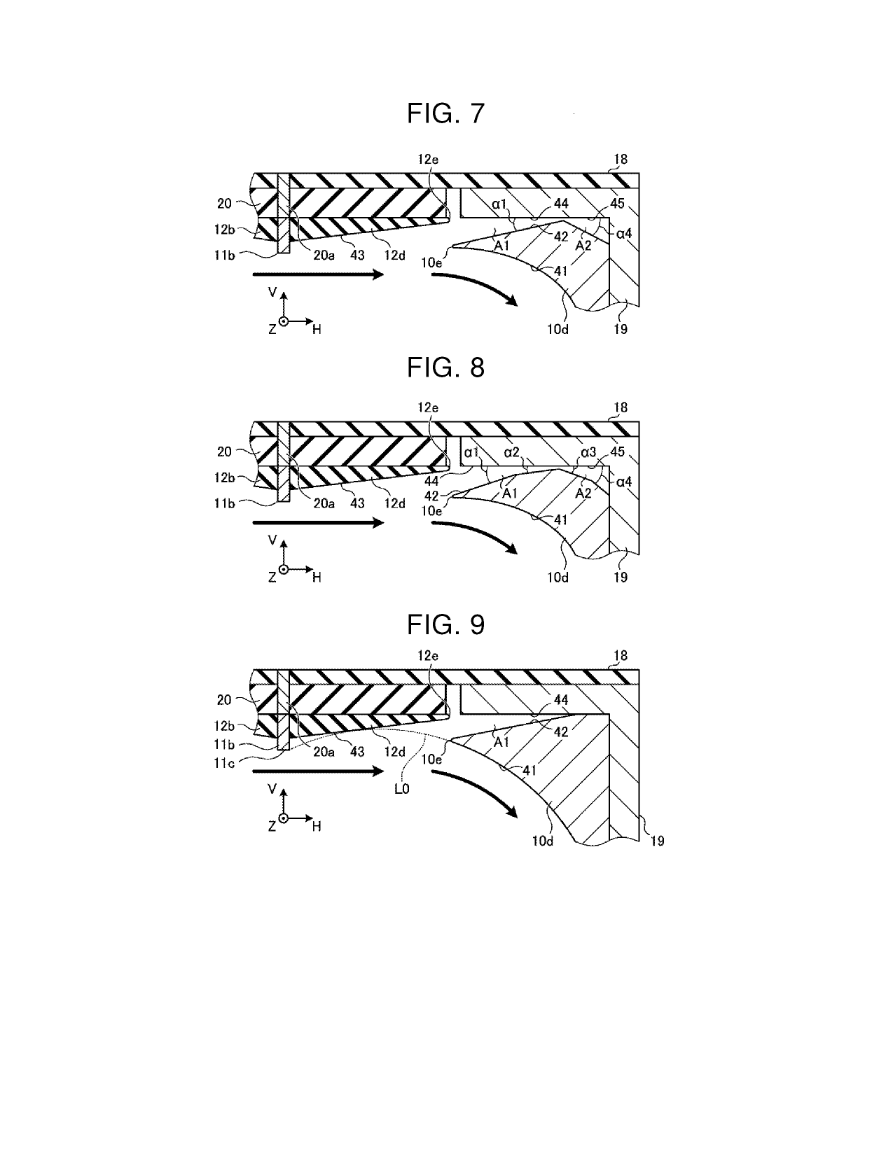

FIG. 7 shows the vicinity of the boundary between the first guide 10d and the inclined member 12d in a third embodiment in an enlarged manner. In the third embodiment, a second space A2 communicating with the first space A1 is formed behind the first space A1 between the second surface 42 and the inner surface of the container 19. The second space A2 has a shape that expands in the V direction as being away from the first space A1.

In the second space A2, an angle α4 formed between the second surface 42 and a surface 45, in contact with the second space A2, of the inner surface of the container 19 is equal to or more than 0° and less than 180°, and is different from 180°/N when N is an arbitrary natural number.

### 5.2 Effect

(12) According to the third embodiment, the second space A2 communicating with the first space A1 is formed behind the first space A1 between the second surface 42 and the inner surface of the container 19.

According to the above, the acoustic wave can be suppressed from returning to the discharge space by being confined in the second space A2.

(13) According to the third embodiment, the second space A2 has a shape that expands as being away from the first space A1.

According to the above, it is possible to suppress the acoustic wave having entered the second space A2 from returning to the first space A1.

In other respects, the third embodiment is similar to the first embodiment. Alternatively, in the third embodiment, the sound absorbing material may be arranged in any one or both of the first space A1 and the second space A2.

### Laser chamber 10 in which angle between second surface 42 and inner surface of container 19 varies in accordance with position in H direction

### 6.1 Configuration

FIG. 8 shows the vicinity of the boundary between the first guide 10d and the inclined member 12d in a fourth embodiment in an enlarged manner.

In the fourth embodiment, the angle α1, α2 formed between the second surface 42 and the surface 44 in the first space A1 becomes smaller toward the depth in the first space A1. For example, the angle α2 at a position farther from the second discharge electrode 11b is smaller than the angle α1 at a position closer to the second discharge electrode 11b in the first space A1. Alternatively, the angle formed between the second surface 42 and the surface 44 may vary in multiple stages, or the angle formed between the second surface 42 and the surface 44 vary continuously by the second surface 42 being formed of a curved surface.

In the fourth embodiment, the angle α3, α4 formed between the second surface 42 and the surface 45 in the second space A2 becomes larger as the distance from the first space A1 increases. For example, the angle α4 at a position farther from the first space A1 is larger than the angle α3 at a position closer to the first space A1 in the second space A2. Alternatively, the angle formed between the second surface 42 and the surface 45 may vary in multiple stages, or the angle formed between the second surface 42 and the surface 45 vary continuously by the second surface 42 being formed of a curved surface.

### 6.2 Effect

(14) According to the fourth embodiment, the angle α1, α2 formed between the second surface 42 and the surface 44, in contact with the first space A1, of the inner surface of the container 19 becomes smaller along the first direction toward the depth of the first space A1.

According to the above, the acoustic wave can be attenuated in the first space A1 by the angle becoming smaller toward the depth of the first space A1.

(15) According to the fourth embodiment, the second space A2 communicating with the first space A1 is formed behind the first space A1 between the second surface 42 and the inner surface of the container 19. The angle α3, α4 formed between the second surface 42 and the surface 45, in contact with the second space A2, of the inner surface of the container 19 becomes larger as the distance from the first space A1 increases.

According to the above, it is possible to suppress the acoustic wave having entered the second space A2 from returning to the first space A1.

In other respects, the fourth embodiment is similar to the third embodiment.

### Laser chamber 10h in which cross section of first surface 41 has logarithmic spiral shape

### 7.1 Configuration

FIG. 9 shows the vicinity of the boundary between the first guide 10d and the inclined member 12d in a fifth embodiment in an enlarged manner. In the fifth embodiment, when viewed in cross section in a plane perpendicular to the Z direction, the shape of the first surface 41 of the first guide 10d substantially matches the shape of a logarithmic spiral L0. Substantially matching the shape of the logarithmic spiral L0 means extending between the following first and second virtual logarithmic spirals L1, L2.

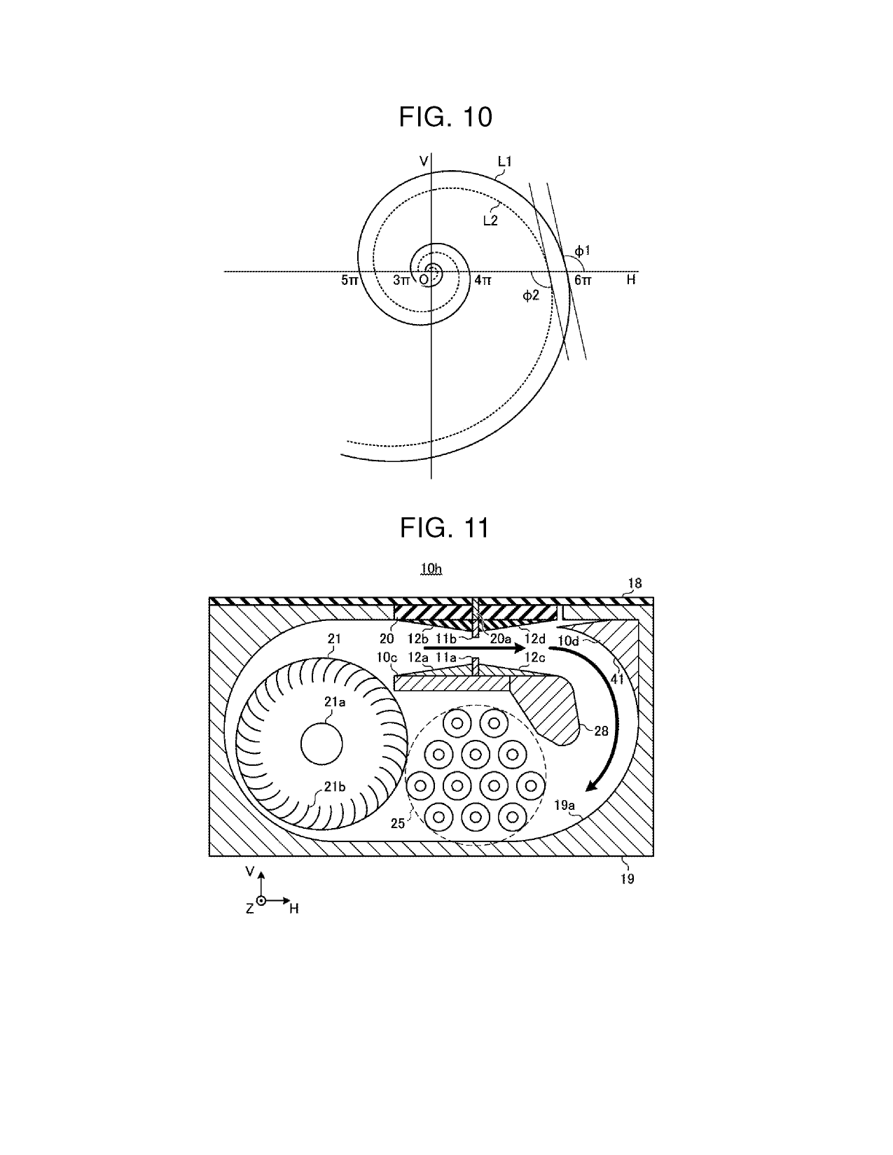

FIG. 10 shows the first and second virtual logarithmic spirals L1, L2. Each of the first and second virtual logarithmic spirals L1, L2 is curved with decreasing curvature along the flow direction of the laser gas. The first virtual logarithmic spiral L1 is a virtual logarithmic spiral in which an angle φ1 at which a straight line from the origin O and a tangent line of the first virtual logarithmic spiral L1 intersect each other is 103°. The second virtual logarithmic spiral L2 is a virtual logarithmic spiral in which an angle φ2 at which a straight line from the origin O and a tangent line of the second virtual logarithmic spiral L2 intersect each other is 96°. In the first and second virtual logarithmic spirals L1, L2, the angles φ1, φ2 differ from each other, but the origin O is the same.

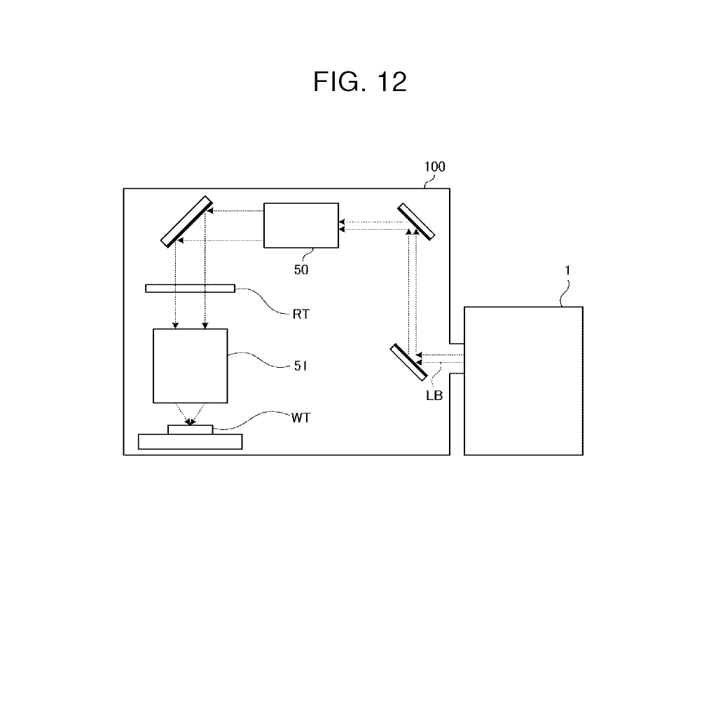

FIG. 11 shows the configuration of the laser chamber 10h in the fifth embodiment as viewed in the -Z direction.

Not only the first surface 41 but also the inner surface 19a of the container 19 configuring the gas flow path between the first guide 10d and the cooling unit 25 may also be located between the first and second virtual logarithmic spirals L1, L2.

Referring back to FIG. 9, it is desirable that not only the first surface 41 but also at least a part of the third surface 43 of the inclined member 12d is located between the first and second virtual logarithmic spirals L1, L2. Further, it is desirable that not only the first surface 41 but also a discharge surface 11c of the second discharge electrode 11b close to the inclined member 12d is located between the first and second virtual logarithmic spirals L1, L2. The discharge surface 11c refers to a surface facing the first discharge electrode 11a.

### 7.2 Effect

(16) According to the fifth embodiment, when the laser chamber 10 is viewed in cross section in a VH plane perpendicular to both the first surface 41 and the second surface 42, the first surface 41 extends between the first virtual logarithmic spiral L1 and the second virtual logarithmic spiral L2. In the first virtual logarithmic spiral L1, the curvature decreases along the flow direction of the laser gas, and the angle φ1 at which the straight line from the origin O and the tangent line of the first virtual logarithmic spiral L1 intersect with each other is 103°. In the second virtual logarithmic spiral L2, the curvature decreases along the flow direction of the laser gas, and the angle φ2 at which the straight line from the origin O and the tangent line of the second virtual logarithmic spiral L2 intersect with each other is 96°.

According to the above, by extending the first surface 41 between the first and second virtual logarithmic spirals L1, L2 in which the curvature decreases along the flow direction of the laser gas, it is possible to suppress increasing of the flow path resistance due to occurrence of stagnation of the laser gas in the vicinity of the first surface 41.

(17) According to the fifth embodiment, at least a part of the third surface 43 is located between the first virtual logarithmic spiral L1 and the second virtual logarithmic spiral L2.

According to the above, since at least a part of the third surface 43 is located between the first and second virtual logarithmic spirals L1, L2, it is possible to suppress occurrence of stagnation of the laser gas in the gas flow path from the vicinity of the third surface 43 to the vicinity of the first surface 41.

(18) According to the fifth embodiment, the discharge surface 11c of the second discharge electrode 11b close to the inclined member 12d among the first and second discharge electrodes 11a, 11b is located between the first virtual logarithmic spiral L1 and the second virtual logarithmic spiral L2.

According to the above, since the discharge surface 11c of the second discharge electrode 11b is located between the first and second virtual logarithmic spirals L1, L2, it is possible to suppress occurrence of stagnation of the laser gas in the gas flow path from the vicinity of the second discharge electrode 11b to the vicinity of the first surface 41.

In other respects, the fifth embodiment is similar to the first embodiment. Alternatively, in the fifth embodiment, the second space A2 may be provided, the sound absorbing material 10g may be arranged in the first space A1 or the second space A2, and the angle formed between the second surface 42 and the surface 44 or 45 may vary in accordance with the position in the H direction.

### Others

### 8.1 Electronic device manufacturing method

FIG. 12 shows the configuration of an exposure system. The exposure system includes the laser device 1 and the exposure apparatus 100. The laser device 1 is configured to output the laser light LB toward the exposure apparatus 100.

The exposure apparatus 100 includes an illumination optical system 50 and a projection optical system 51. The illumination optical system 50 illuminates a reticle pattern of a reticle (not shown) arranged on a reticle stage RT with the laser light LB incident from the laser device 1. The projection optical system 51 causes the laser light LB transmitted through the reticle to be imaged as being reduced and projected on a workpiece (not shown) arranged on a workpiece table WT. The workpiece is a photosensitive substrate such as a semiconductor wafer on which photoresist is applied.

The exposure apparatus 100 synchronously translates the reticle stage RT and the workpiece table WT to expose the workpiece to the laser light LB reflecting the reticle pattern. After the reticle pattern is transferred onto the semiconductor wafer by the exposure process described above, an electronic device can be manufactured through a plurality of processes.

### 8.2 Laser control processor 30

The laser control processor 30 may be physically configured as hardware to execute various processes included in the present disclosure. For example, the laser control processor 30 may be a computer including a memory that stores a control program defining the various processes and a processing device that executes the control program. The control program may be stored in one memory, or may be stored separately in a plurality of memories at physically separate locations, and the various processes included may be defined by the control program as an aggregation thereof. The processing device may be a general-purpose processing device such as a CPU or a special-purpose processing device such as a GPU.

Alternatively, the laser control processor 30 may be programmed as software to execute the various processes included in the present disclosure. For example, the laser control processor 30 may be implemented in a dedicated device such as an ASIC or a programmable device such as an FPGA.

The various processes included in the present disclosure may be executed by one computer, one dedicated device, or one programmable device, or may be executed by cooperation of a plurality of computers, a plurality of dedicated devices, or a plurality of programmable devices at physically separate locations. The various processes may be executed by a combination including at least any two of: one or more computers, one or more dedicated devices, and one or more programmable devices.

### 8.3 Supplement

The description above is intended to be illustrative and the present disclosure is not limited thereto. Therefore, it would be obvious to those skilled in the art that various modifications to the embodiments of the present disclosure would be possible without departing from the spirit and the scope of the appended claims. Further, it would be also obvious to those skilled in the art that the embodiments of the present disclosure would be appropriately combined.

The terms used throughout the present specification and the appended claims should be interpreted as non-limiting terms unless clearly described. For example, terms such as “comprise”, “include”, “have”, and “contain” should not be interpreted to be exclusive of other structural elements. Further, indefinite articles “a/an” described in the present specification and the appended claims should be interpreted to mean “at least one” or “one or more”. Further, “at least one of A, B, and C” should be interpreted to mean any of A, B, C, A+B, A+C, B+C, and A+B+C as well as to include combinations of any thereof and any other than A, B, and C.

What is claimed is:

1. A laser chamber comprising:
a container configured to accommodate a laser gas;
a pair of discharge electrodes;
a fan configured to cause the laser gas to circulate;
a first guide including a first surface and a second surface, the first surface being configured to guide the laser gas therealong, and the second surface and an inner surface of the container forming a first space that narrows in a first direction toward depth; and
a second guide including a third surface configured to guide the laser gas therealong toward a vicinity of the first guide.

2. The laser chamber according to claim 1,
wherein the first direction is a direction away from the discharge electrodes.

3. The laser chamber according to claim 1,
wherein an angle formed between the second surface and a surface, in contact with the first space, of the inner surface of the container is more than 0° and less than 90°, and is different from 180°/N when N is an arbitrary natural number.

4. The laser chamber according to claim 1,
wherein an extension surface of the third surface passes through the first space.

5. The laser chamber according to claim 4,
wherein an angle formed between the second surface and the third surface is more than 0° and less than 90°, and is different from 180°/N when N is an arbitrary natural number.

6. The laser chamber according to claim 1,
wherein an upstream end portion of the first guide in a flow direction of the laser gas and a downstream end portion of the second guide in the flow direction of the laser gas are at different positions in a second direction perpendicular to a surface, in contact with the first space, of the inner surface of the container.

7. The laser chamber according to claim 1,
wherein the second surface is longer in the first direction than a surface, in contact with the first space, of the inner surface of the container.

8. The laser chamber according to claim 1,
wherein a part of the first guide and a part of the second guide are at positions overlapping each other when viewed in a second direction perpendicular to a surface, in contact with the first space, of the inner surface of the container.

9. The laser chamber according to claim 1,
wherein a plurality of grooves are formed on either the second surface or a surface, in contact with the first space, of the inner surface of the container.

10. The laser chamber according to claim 1,
wherein a sound absorbing material is arranged in the first space.

11. The laser chamber according to claim 10,
wherein the sound absorbing material is arranged so as to cover either the second surface or a surface, in contact with the first space, of the inner surface of the container.

12. The laser chamber according to claim 1,
wherein a second space communicating with the first space is formed behind the first space between the second surface and an inner surface of the container.

13. The laser chamber according to claim 12,
wherein the second space has a shape that expands as being away from the first space.

14. The laser chamber according to claim 1,
wherein an angle formed between the second surface and a surface, in contact with the first space, of the inner surface of the container becomes smaller along the first direction of the first space.

15. The laser chamber according to claim 1,
wherein a second space communicating with the first space is formed behind the first space between the second surface and an inner surface of the container, and
an angle formed between the second surface and a surface, in contact with the second space, of the inner surface of the container becomes larger as the distance from the first space increases.

16. The laser chamber according to claim 1,
wherein, when the laser chamber is viewed in cross section in a plane perpendicular to both the first surface and the second surface, the first surface extends between a first virtual logarithmic spiral whose curvature decreases along the flow direction, the first virtual logarithmic spiral having an angle of 103° at which a straight line from an origin and a tangent line of the first virtual logarithmic spiral intersect each other, and a second virtual logarithmic spiral whose curvature decreases along the flow direction, the second virtual logarithmic spiral having an angle of 96° at which a straight line from the origin and a tangent line of the second virtual logarithmic spiral intersect each other.

17. The laser chamber according to claim 16,
wherein at least a part of the third surface is located between the first virtual logarithmic spiral and the second virtual logarithmic spiral.

18. The laser chamber according to claim 16,
wherein a discharge surface of one of the discharge electrodes close to the second guide is located between the first virtual logarithmic spiral and the second virtual logarithmic spiral.

19. A discharge-excitation-type gas laser device comprising:
an optical resonator; and
a laser chamber according to claim 1 arranged on an optical path of the optical resonator.

20. An electronic device manufacturing method, comprising:
generating laser light using a discharge-excitation-type gas laser device including a laser chamber;
outputting the laser light to an exposure apparatus; and
exposing a photosensitive substrate to the laser light in the exposure apparatus to manufacture an electronic device,
the laser chamber including:
a container configured to accommodate a laser gas;
a pair of discharge electrodes;
a fan configured to cause the laser gas to circulate;
a first guide including a first surface and a second surface, the first surface being configured to guide the laser gas therealong, and the second surface and an inner surface of the container forming a first space that narrows in a first direction toward depth; and
a second guide including a third surface configured to guide the laser gas therealong toward a vicinity of the first guide.
